(19) United States
(12) Patent Application Publication
(10) Pub. No.: US 2007/0219930 A1
(43) Pub. Date: Sep. 20, 2007

(54) Systems and methods for selecting a least cost technology

(75) Inventors: Bassel H. Daoud, Parsippany, NJ (US); Christopher K. Wiese, Long Valley, NJ (US)

Correspondence Address: PRIEST & GOLDSTEIN, PLLC, 5015 SOUTHPARK DR, SUITE 230, DURHAM, NC, 27713, US

(73) Assignee: Lucent Technologies Inc., Murray Hill, NJ (US)

(21) Appl. No.: 11/376,798

(22) Filed: Mar. 16, 2006

(51) Int. Cl. G06F 17/00

(52) U.S. Cl. 705/400

(57) ABSTRACT

Techniques for determining a business case for selecting a least cost technology are described. To this end, forecast sales data of one or more configurations of an assembled product is received. Usage factors of a plurality of subcomponents composing the assembled product are also received. A usage factor may suitably correspond to a combination of subcomponents to meet a configuration of the assembled product for one of the plurality of technologies. Cost data for subcomponents composing the plurality of technologies is also received. A technology cost for each of the plurality of technologies according to the forecast sales data of one or more configurations of the assembled product is calculated to define the business case for selecting the least cost technology.

### FIELD OF THE INVENTION

The present invention relates generally to improvements in the field of business enterprise decision making, and, in particular, to systems and methods for selecting a least cost technology.

### BACKGROUND OF THE INVENTION

Typically, the price at which an assembled product can be sold drops rather quickly over the life time of the product. An assembled product such as a telecommunication base station may comprise many subcomponents including filters, amplifiers, radios, and the like. Furthermore, the telecommunication base station may be sold in various configurations to meet customer scaling requirements. Each configuration may include a different quantitative mix of subcomponents. To be competitive in today's global economy and maintain a consistent profit, a business enterprise, which builds and sells the assembled product, needs to manage the costs of these subcomponents.

Many times these subcomponents can be replaced by cheaper subcomponents due to technology advances, manufacturing efficiency, and the like. Integrating new subcomponents into an assembled product can prove costly depending on the new subcomponents complexity, physical dimension, connectivity to other subcomponents, and the like. For example, a new subcomponent may require additional software for it to operate in the assembled product, a new wiring plan to electrically connect the new subcomponent to the assembly, or a new packaging plan for the assembled product.

Additionally, many times there is no one-for-one replacement of subcomponents available or, perhaps, a new subcomponent contains functionality which spans two or more old components. A whole new set of subcomponents may then be utilized to replace an existing set of subcomponents. Each set of subcomponents utilized to meet the configurations of an assembled product defines a technology. Furthermore, different technologies may be assembled to address the same configurations of an assembled product.

Since operating budgets of the business enterprise are limited, how does the business enterprise decide which subcomponents should be replaced? Or if a replacement strategy requires new technology in that there does not exist a one-for-one subcomponent replacement strategy, how does a business enterprise decide which technology such as a specific mix of replacement subcomponents to pursue? In other words, how does a business enterprise establish a business case for selecting which technology to pursue? Will a change in forecast for an assembled component affect the choice of technology to pursue? Conventionally, management teams of the business enterprise introduce new technology on an adhoc basis without being able to answer these and other related questions, resulting in wasting time on replacing subcomponents which do not affect the bottom line, increased development costs, and shrinking profits, if any at all remain after introducing the new subcomponents.

### SUMMARY OF THE INVENTION

Among its several aspects, the present invention recognizes the need for determining a business case for cost reduction projects of subcomponents composing one or more assembled products. Another aspect of the present invention includes systems and methods for determining a business case for selecting a least cost technology. To this end, forecast sales data of one or more configurations of an assembled product is received. Usage factors of a plurality of subcomponents composing the assembled product are also received. A usage factor corresponds to a combination of subcomponents to meet a configuration of the assembled product for one of the plurality of technologies. Cost data for subcomponents composing the plurality of technologies is also received. A technology cost for each of the plurality of technologies according to the forecast sales data of one or more configurations of the assembled product is calculated to define the business case for selecting the least cost technology.

A more complete understanding of the present invention, as well as further features and advantages of the invention, will be apparent from the detailed description, the accompanying drawings, and the claims.

### BRIEF DESCRIPTION OF THE DRAWINGS

FIG. 1 shows an illustrative system employing a cost reduction project management system in accordance with the present invention.

FIG. 2 shows exemplary software components of and interfacing to the cost reduction project management software 130 of FIG. 1 in accordance with the present invention.

FIGS. 3A and 3B (collectively FIG. 3) show a flow chart of an overall method for managing cost reduction projects in accordance with the present invention.

FIGS. 4A and 4B (collectively FIG. 4) show a flow chart of a method for determining a best of the best assembled product according to subcomponent costs and market based target costs in accordance with the present invention.

FIG. 5 shows a flow chart of a method for determining forecast schedule data for subcomponents common across one or more assembled products in accordance with the present invention.

FIG. 6 shows a flow chart of a method for determining the set of cost reduction projects to pursue in accordance with the present invention.

FIG. 7 shows a flow chart of a method for extracting additional overall cost savings by advancing the general availability (GA) date of high savings cost reduction projects in accordance with the present invention.

FIG. 8 shows an exemplary spreadsheet utilized in implementing a first portion of the business case component of FIG. 2 in accordance with the present invention.

FIG. 9 shows an exemplary forecast spreadsheet of the subcomponents composing three different technologies of an assembled product in accordance with the present invention.

FIG. 10 shows an exemplary spreadsheet showing monthly costs for three technologies in accordance with the present invention.

FIG. 11 shows an exemplary spreadsheet showing year to date costs for three technologies in accordance with the present invention.

### DETAILED DESCRIPTION

The present invention will now be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

As will be appreciated by one of skill in the art, the present invention may be embodied as methods, systems, or computer readable media. Furthermore, the present invention may take the form of a computer program on a computer-usable storage medium having computer-usable program code embodied in the medium. Any suitable computer readable medium may be utilized including hard disks, CD-ROMs, optical storage devices, flash memories, magnetic storage devices, or the like.

Computer program code or “code” for carrying out operations according to the present invention may be written in an object oriented programming language such as JAVA®, JavaScript®, Visual Basic®, C, C++ or in various other programming languages or may be written in the form of a spreadsheet such as one which is run in a Microsoft Excel® or Lotus 123 operating environment. Software embodiments of the present invention do not depend on implementation with a particular programming language. Portions of the code may execute entirely on one or more systems utilized by a server in the network or a mobile device.

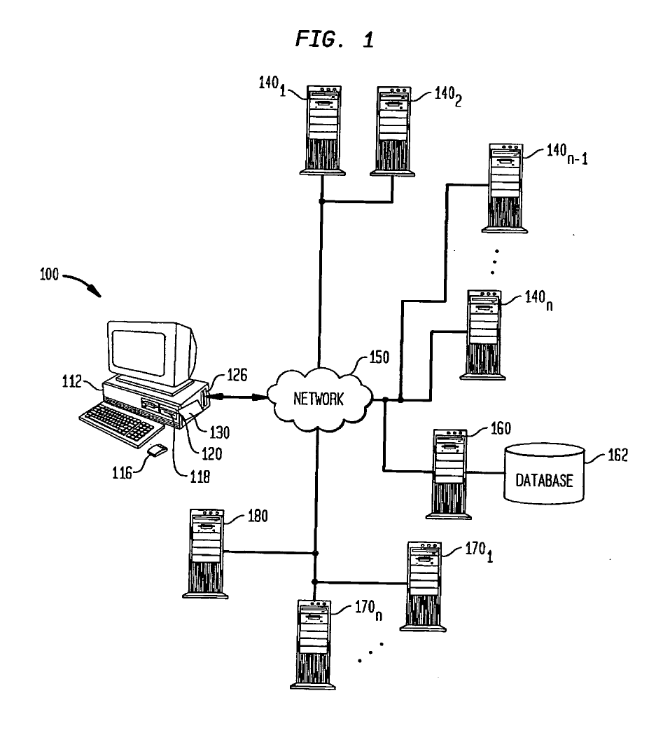

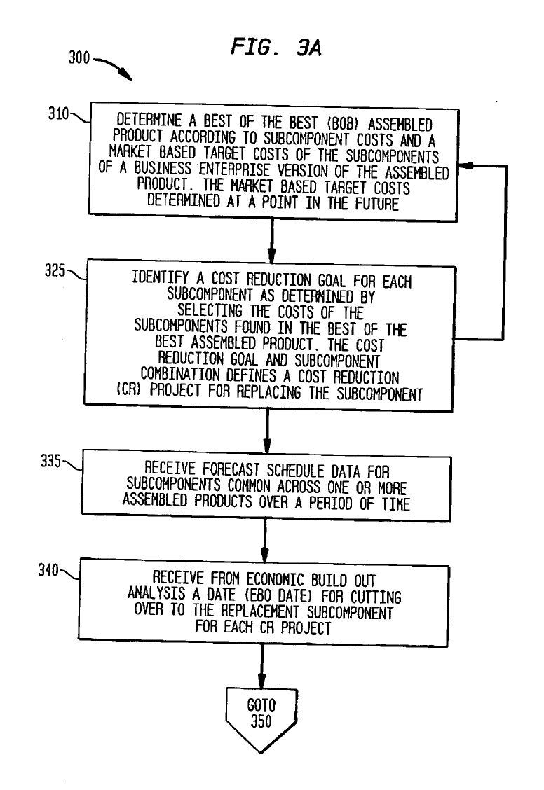

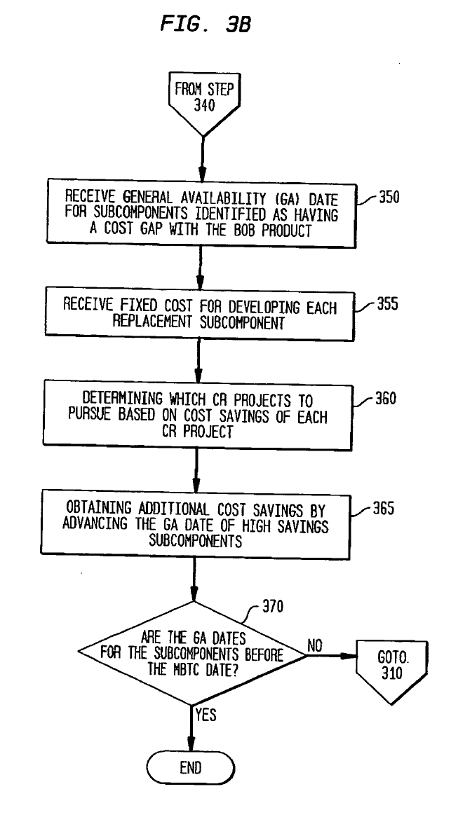

FIG. 1 shows a diagram of a system 100 employing a cost reduction project management system in accordance with the present invention. The illustrated system 100 is shown implemented as a stand-alone personal computer or workstation 112. As described in further detail below, system 100 includes cost reduction project management software 130 in accordance with the present invention which is stored in memory and run by the central processing unit of the personal computer 112. The presently preferred cost reduction project management software 130 is embodied in an Excel spreadsheet. However, the present invention contemplates that the data stored in the Excel spreadsheet may alternatively be stored in a database. In that environment, the cost reduction project management software 130 may be embodied as a program which stores, retrieves, and modifies the data in the database. Cost reduction project management software 130 achieves one or more of the steps defined in FIG. 3.

The computer 112 includes a number of standard input and output devices, including a keyboard 114, mouse 116, CD-ROM drive 118, disk drive 120, and monitor 122. Optionally, the computer 112 includes an Internet or network connection 126 to automatically retrieve over network 150 input data utilized by cost reduction project management software 130 such as inventory data of sub-components from remote suppliers utilizing known systems such as electronic manufacturer services (EMS), supply chain portal, Webplan®, DataMart® implemented on computing systems 140₁ . . . 140ₙ, respectively, general availability dates for subcomponents from design and development system 180, forecast data for assembled product from customer systems 170₁ . . . 170ₙ or a sales system 160 containing a database 162 which tracks won and lost contracts. Alternatively or in combination with automatically retrieving input data over network 150, input data may be manually inputted into cost reduction project management software 130.

It will be appreciated, in light of the present description of the invention, that the present invention may be practiced in any of a number of different computing environments without departing from the scope of the invention. For example, the system 100 may be implemented with portions of the cost reduction project management software 130 executing on one or more workstations connected to each other over network 150 or a portion of the cost reduction project management software 130 may execute on a server while a complementary portion of the cost reduction project management software 130 may execute on a workstation networked to the server. Also, other input and output devices such as laptops, handheld devices, or cell phones, for example, may be used, as desired.

One embodiment of the invention has been designed for use on a stand-alone personal computer, laptop, or workstation on an Intel Pentium or later processor, using as an operating system Windows XP, Windows NT, Linux, or the like.

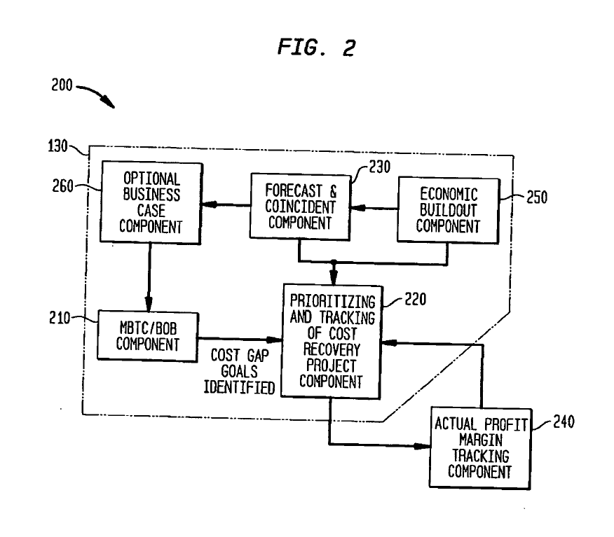

FIG. 2 shows the software components of and interfacing to the cost reduction project management software 130 of FIG. 1 for managing cost reduction projects in accordance with the present invention. Cost reduction project management software 130 includes a market based target cost (MBTC)/best of the best (BOB) component 210, a prioritizing and tracking component 220, an economic buildout component 250, a forecast and coincident component 230, and a business case component 260. Cost reduction project management software 130 interfaces with a known actual profit margin tracking component 240. The actual profit margin tracking component 240 receives projected cost savings from the prioritizing and tracking of cost reduction project component 220 and revenue data for sold product.

The economic buildout component 250 utilizes cost data of old and new unique subcomponents and weekly and total forecast or demand for an assembled product to determine at what point in time the old assembled product should cease assembly and the new assembled product should begin assembly. An exemplary embodiment of an economic buildout component 250 is discussed further in commonly owned patent application entitled “System and Methods For Reducing Stranded Inventory” U.S. patent application Ser. No. ______, filed concurrently with this application which is hereby incorporated by reference herein in its entirety.

The forecast and coincident component 230 receives sales forecast data for one or more configurations of an assembled product, decomposes the one or more configurations into subcomponents, and determines a forecast schedule over time for the subcomponents composing the one or more configurations. An exemplary embodiment of the forecast and coincident component 230 is discussed further in commonly owned patent application entitled “System and Methods for Producing a Forecast Schedule of Subcomponents” U.S. patent application Ser. No. ______, filed concurrently with this application which is hereby incorporated by reference herein in its entirety.

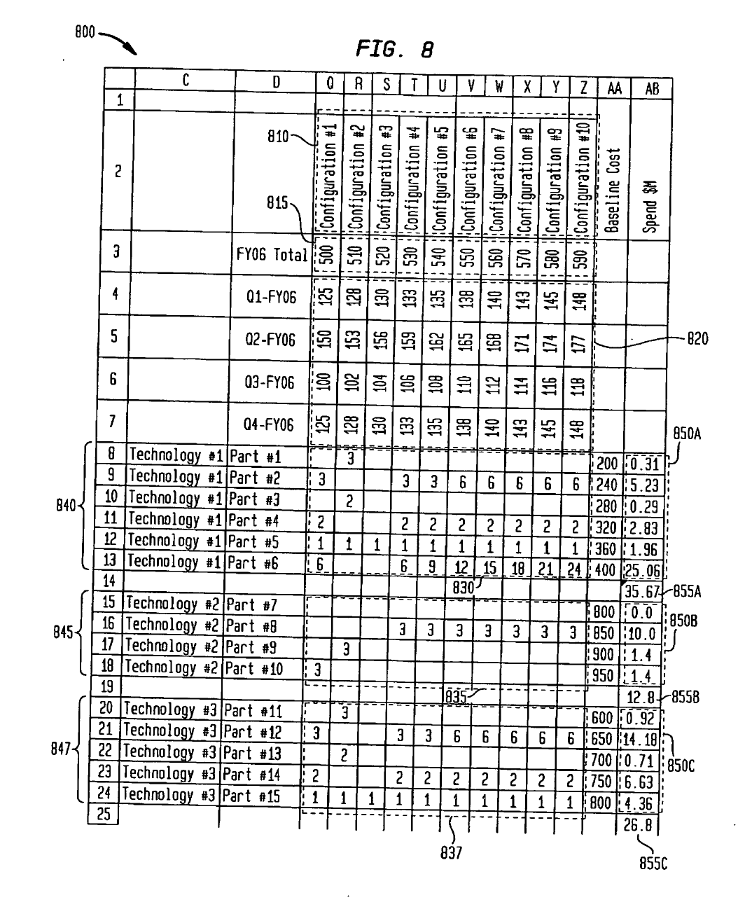

The optional business case component 260 compares costs of subcomponents of two or more technologies which address configurations of an assembled product over a period of time. The optional business case component 260 may receive sales forecast data from the forecast and coincident component 230 or from manual input for subcomponents over time and across a variety of configurations of the assembled product. The optional business case component 260 also receives usage data of subcomponents of a technology to address configurations of the assembled product. The optional business case component 260 determines relative cost savings over time between the one or more technologies according to a forecast plan of the assembled product. The optional business case component 260 may automatically select the most cost effective technology for a given forecast plan. The selected technology and corresponding usage data associated with the subcomponents defining the technology may be transferred to the market based target cost (MBTC)/best of the best (BOB) component 210. An exemplary embodiment of the optional business case component 260 is discussed further in connection with the discussion of FIGS. 8-13.

The market based target cost (MBTC)/best of the best (BOB) component 210 receives competitive data on competitor's equivalent product costs, price erosion trends and determines two items. First, a best of the best assembled product is determined by selecting the least cost subcomponent from one or more competitor products and the business enterprise's assembled product and aggregating the selected least cost subcomponent to compose the best of the best assembled product. Second, a market based target cost or goal takes into account a constant profit margin to be achieved at a later point in time. The later point in time is the estimated amount of time it would take to develop and integrate the subcomponents composing the BOB product. Comparing the subcomponent costs of the BOB product with the business enterprise's assembled product identifies cost gaps of like subcomponents between the two. Additionally, if the BOB product is greater than the market based target cost, the subcomponent costs of the BOB product are reduced accordingly. An example of how to determine the BOB cost and market based target cost (MBTC) is discussed further in commonly owned patent application entitled “System and Methods of Managing Cost Reduction Projects to Increase Cost Savings of Replacement Subcomponents” U.S. patent application Ser. No. ______, filed concurrently with this application which is hereby incorporated by reference herein in its entirety.

The prioritizing and tracking component 220 receives the fixed cost for developing each new subcomponent, the cutover date from the economic buildout component 250, a general availability date from the design/development team assigned to develop and integrate the new subcomponent into the assembled product and the forecast schedule on a subcomponent basis from the forecast and coincident component 230. The general availability date represents the date at which the new subcomponent will be assembled in the new product for delivery to customers. The prioritizing and tracking component 220 based on cost savings, development cost, and the forecast schedule over which subcomponents will save the most money for the business enterprise over time allows the business enterprise to select which new subcomponents should be pursued. The prioritizing and tracking component 220 also allows subcomponent cost reduction projects to be grouped into sets of cost reduction projects according to resources such as personnel, tools, and the like. Each set of cost reduction projects are assigned to project owners who have authority to assign resources across the set of cost reduction projects. The prioritizing and tracking component 220 further provides means to advance a GA date for one subcomponent and delay a GA date for another subcomponent in order to save additional total costs. An exemplary embodiment of the prioritizing and tracking component 220 is discussed further in commonly owned patent application entitled “System and Methods for Prioritizing and Tracking Cost Reduction Projects” U.S. patent application Ser. No. ______, filed concurrently with this application which is hereby incorporated by reference herein in its entirety.

The actual profit margin tracking component 240 receives as input a cost roadmap specifying the cost of subcomponents as a function of time and the actual sales of assembled product containing the subcomponents. The actual profit margin tracking component 240 calculates the total cost of an assembled product containing replaced subcomponents and the total cost of the assembled product containing new subcomponents to calculate a percent reduction in cost. This percent reduction in cost is compared to the BOB product to determine whether the targets/goals established by the MBTC/BOB component 210 are accomplished.

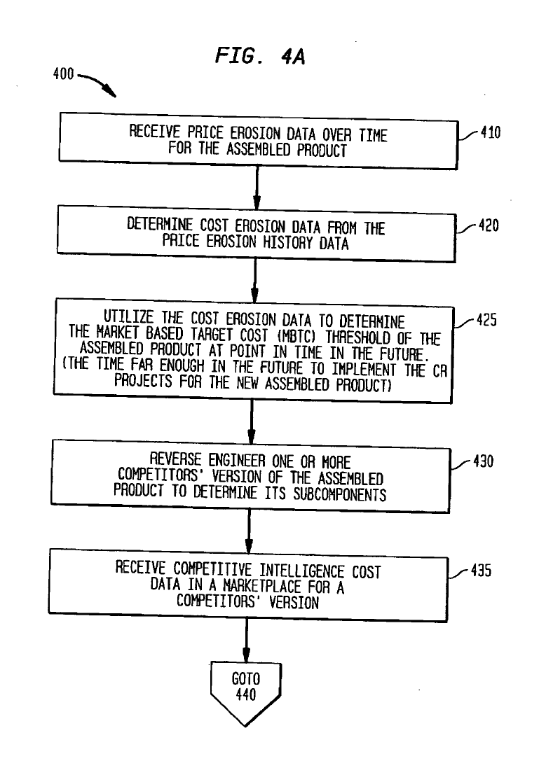

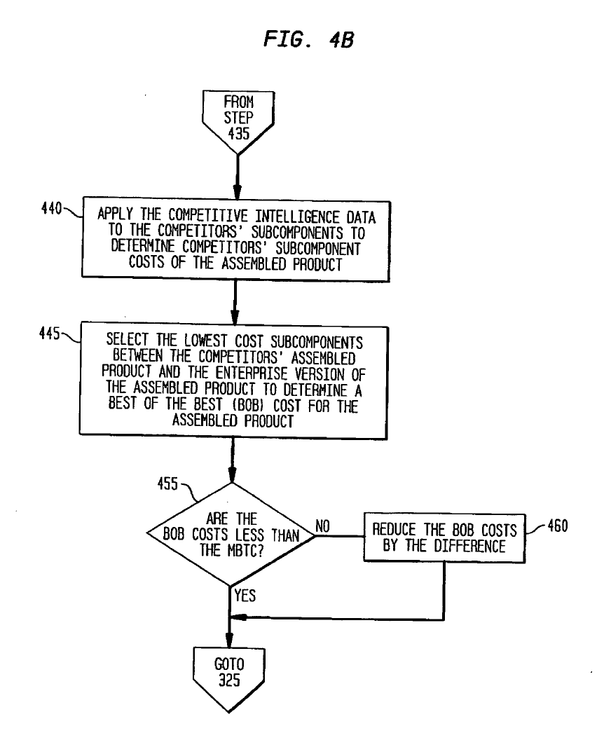

FIG. 3 shows a flow chart of an overall method 300 for managing cost reduction projects in accordance with the present invention. The components of FIG. 2 when executed by system 100 perform one or more of the steps described in the overall method to manage the cost reduction projects. At step 310, a best of the best (BOB) assembled product according to subcomponent costs and market based target costs of the subcomponents of a business enterprise version of the assembled product is determined by, for example, the MBTC/BOB component 210. Further details for determining the BOB assembled product will be discussed in connection with FIG. 4. The market based target costs are determined at a point in the future. The point in the future is a date which initially estimates an amount of time to design, develop and deliver a new assembled product with one or more new subcomponents.

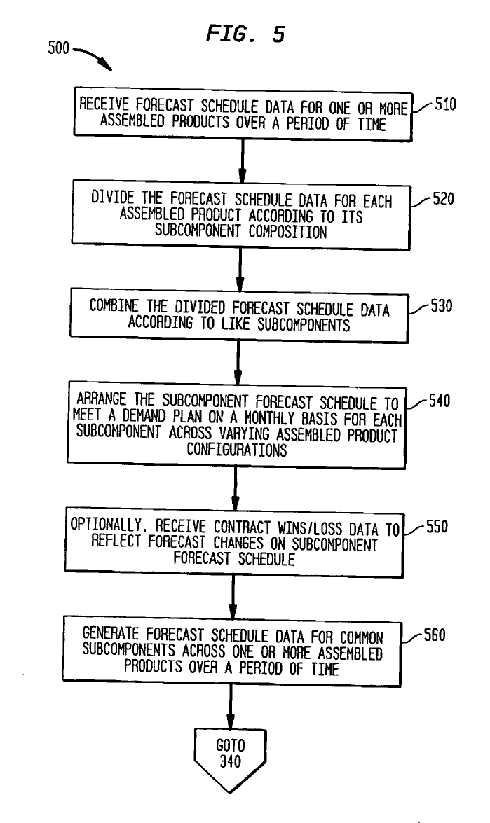

At step 325, a cost reduction goal for each subcomponent is identified by selecting the costs of the subcomponents found in the best of the best assembled product. The cost reduction goat and subcomponent combination defines a cost reduction (CR) project for replacing the subcomponent in a newly assembled product. In some cases, the subcomponent will be replaced with a less expensive version. In other cases, a subcomponent's function may be integrated into a new subcomponent which replaces more than one old subcomponent. At step 335, forecast schedule data for subcomponents common across one or more assembled products over a period of time are received by, for example, the forecast and coincident component 230. Further details for determining forecast schedule data for subcomponents will be discussed in connection with FIG. 5.

At step 340, an economic build out (EBO) analysis date is received. The EBO date indicates the cutover date at which the new product should be assembled in order to either minimize cost and/or stranded inventory. Further details for determining that cutover date are discussed in commonly owned patent application entitled “System and Methods For Reducing Stranded Inventory” U.S. patent application Ser. No. ______.

At step 350, the general availability (GA) date for subcomponents identified as having cost gaps in step 325 is received by, for example, the prioritizing and tracking component 220. These GA dates may be supplied by a development team assigned to developing the new replacement subcomponent. At step 355, fixed costs for developing each replacement subcomponent are received by, for example, the prioritizing and tracking component 220. The fixed costs may be supplied by project managers assigned to tracking the development projects for each replacement subcomponent.

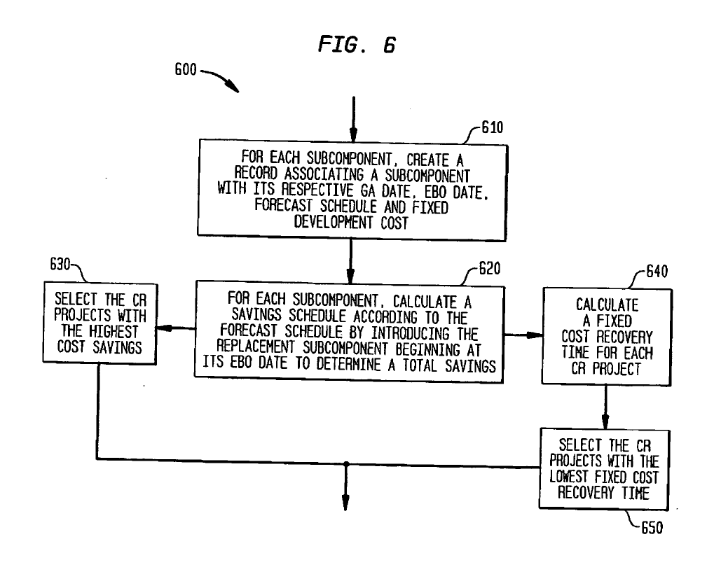

Due to a business enterprises budgetary and/or resource constraints, it may be too costly to pursue each cost reduction project. At step 360, the set of cost reduction projects to pursue, out of those identified as having cost gaps with the BOB, is determined based on the cost savings produced by each cost reduction project. Further details for determining which cost reduction projects to pursue will be discussed in connection with FIG. 6.

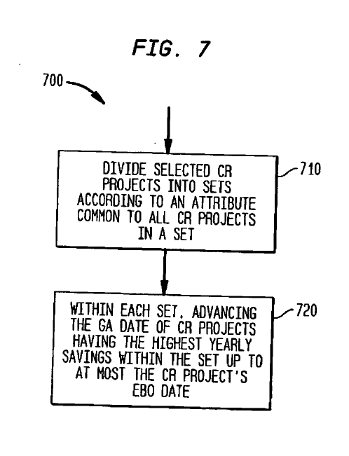

At step 365, additional overall cost savings are obtained by advancing GA dates on subcomponents having high cost savings. Cost savings are advanced when the GA date for a corresponding cost reduction project is made sooner in time. Cost savings are delayed when the GA date for a corresponding cost reduction project is made later in time. Since the GA date is provided by the development team, advancing a GA date would correspond to allocating additional resources to the corresponding cost reduction project and delaying a GA date would typically correspond to removing resources from the corresponding cost reduction project. In order to balance overall resource allocation, when a GA date is advanced on a cost reduction project, a GA date of another cost reduction project is typically delayed. At step 370, the GA dates for all the cost reduction projects are compared against the market based target cost date. Recalling that the MBTC date is an initial estimate, it is compared against the GA dates of the cost reduction projects to see if method 300 should be iterated again. If the GA dates are after the MBTC date, then a new MBTC date should be determined. In that case, method 300 proceeds to step 310. Otherwise, method 300 ends. Further details for extracting additional cost savings determining which cost reduction projects to pursue will be discussed in connection with FIG. 7.

FIG. 4 shows a flow chart of a method 400 for determining a best of the best assembled product according to subcomponent costs and market based target costs in accordance with the present invention. In particular, method 400 further defines step 310 and one or more of the steps of method 400 may be performed by the MBTC/BOB component 210. At step 410, price erosion data over time for an assembled product is received by, for example, the MBTC/BOB component 210. The price erosion data is forward looking in time and reflects a decrease in price due to factors such a shrinking market demand, manufacturing efficiencies, or the like. At step 420, cost erosion data is determined from the price erosion data to sustain profitability. For example, a business enterprise may require a 50% profit margin on an assembled product. In that case, the cost erosion data is found by multiplying the price erosion data by 0.50 at each point in time.

At step 425, the cost erosion data at a particular point in time in the future is a market based target cost (MBTC) which acts as a threshold cost of the assembled product at that particular point in time. The particular point in time is typically set far enough in the future to accomplish the cost reduction projects for a new assembled product. At this point in the overall method 300, the particular point in time is an initial estimated date rather than a firm date.

At step 430, one or more competitors' versions of the assembled product are reverse engineered to determine their subcomponents. At step 435, competitive intelligence cost data for the competitors' subcomponents are received. At step 440, the competitive intelligence cost data is applied to the competitors' subcomponents to determine the costs of the competitors' subcomponents of the assembled product. The lowest cost subcomponents between the competitors' assembled product and the enterprise version of the assembled product are selected to determine a best of the best (BOB) cost for the individual costs for the subcomponents in the assembled product. At step 450, the method compares the total BOB cost with the MBTC determined in step 425. If the total BOB cost is less than or equal to the MBTC, the BOB cost is more than enough to ensure profitability. Method 400 proceeds to step 325 in overall process 300. If the total BOB cost is greater than the MBTC, the BOB cost for the individual costs for the subcomponents in the assembled product, although reduced from the currently assembled product, will not ensure the business enterprise's profitability. In this case, method 400 proceeds to step 455. At step 455, the BOB cost for the individual costs for the subcomponents in the assembled product is reduced by the difference between the MBTC and the total BOB cost determined in step 445. Various techniques may be utilized to reduce the total BOB cost. One technique includes reducing the cost of each subcomponent composing the BOB product by a pro rata amount. Another technique includes reducing the costs of the highest cost subcomponents, subcomponents whose costs are over a predetermined threshold, by a pro rata amount. Method 400 then proceeds to step 325 utilizing the reduced BOB cost. An example on how to determine the BOB cost and market based target cost (MBTC) will be described in connection with the discussion of FIGS. 8-10.

FIG. 5 shows a flow chart of a method 500 for determining forecast schedule data for subcomponents common across one or more assembled products in accordance with the present invention. In particular, method 500 further defines step 335 and one or more of the steps of method 500 may be performed by the prioritizing and tracking component 220. At step 510, forecast schedule data for one or more assembled products over a period of time is received. The one or more assembled products are composed of subcomponents common between the one or more assembled products. In other words, the one or more assembled products may include varying configurations of an assembled product. The forecast data includes the number of assembled products expected to be sold on a monthly basis for a period of time such as over the next 18 months. At step 520, the forecast schedule data for each assembled product is divided according to its subcomponent composition. At step 530, the divided forecast schedule data is combined according to like subcomponents to define a subcomponent forecast schedule. At step 540, the subcomponent forecast schedule is arranged to meet a demand plan on a monthly basis for each subcomponent across varying assembled product configurations. For example, the subcomponent forecast schedule will indicate the number of each subcomponent expected to be utilized on a monthly basis to satisfy customer orders.

At step 550, contract data including won and lost contracts for the sale of assembled products may optionally be received. If this step is invoked, the subcomponent forecast schedule is updated to reflect additional contracts won and lost. Step 550 allows the subcomponent forecast schedule to dynamically track forecast data at a subcomponent level of granularity. At step 560, forecast schedule data for common subcomponents across one or more assembled products over a period of time is generated. The method 500 returns to step 340 of the overall method 300. An exemplary embodiment of the forecast and coincident component 230 is discussed further in commonly owned patent application entitled “System and Methods for Producing a Forecast Schedule of Subcomponents” U.S. patent application Ser. No. ______.

FIG. 6 shows a flow chart of a method 600 for determining the set of cost reduction projects to pursue in accordance with the present invention. In particular, method 600 further defines step 360 and one or more of the steps of method 600 may be performed by the prioritizing and tracking component 220. At step 610, a record is created for each subcomponent associating a subcomponent with its respective proposed GA data, EBO date, subcomponent forecast schedule, and fixed development cost. At step 620, a savings schedule for each subcomponent is created on a monthly basis according to the subcomponent forecast schedule found in FIG. 5. The savings schedule will begin accumulating savings on the date the replacement subcomponent goes into live production, the subcomponent's proposed GA date.

Two alternative techniques are utilized to select the set of cost reduction projects according to a business enterprise's budgetary constraints. The first technique is defined by step 630. At step 630, the cost reduction projects with the highest total cost savings are selected. The number of cost reduction projects is determined by applying the budgetary constraints to the fixed costs of the highest total cost savings projects until the budgetary constraints are exhausted. The budgetary constraints are consumed by subtracting out the fixed development costs from the highest total cost savings projects until the budgetary constraints are exhausted.

The second technique for selecting the set of cost reduction projects is defined by steps 640 and 650. At step 640, for each subcomponent identified to have a cost gap with the BOB cost, a fixed cost recovery time is calculated. The fixed cost recovery time indicates how long it takes to recover the fixed costs for developing a new subcomponent by savings caused by use of the new subcomponent in the assembled product. The fixed cost recovery time is determined by adding up the monthly cost savings found in step 620 until the sum of the monthly cost savings first equal or exceed the fixed costs for the corresponding new subcomponent. At step 650, the cost reduction projects with the lowest fixed cost recovery times are selected to be pursued. It should be recognized that different multiples of the fixed cost recovery time, such as two times, four times, ten times the fixed costs, and the like, may be utilized by the present invention in order to prioritize the order in which to pursue cost reduction projects.

FIG. 7 shows a flow chart of a method 700 for extracting additional overall cost savings by advancing the GA date of high savings cost reduction projects in accordance with the present invention. In particular, method 700 further defines step 365 and one or more of the steps of method 700 may be performed by the prioritizing and tracking component 220. At step 710, the selected cost reduction (CR) projects found in step 360 are divided into sets where there is a common attribute shared by each of the cost reduction projects. For example, the cost reduction projects may be divided based on design/development personnel resources assigned to the respective cost reduction projects, locations of development resources, suppliers of the corresponding subcomponent, and the like. Preferably, all the cost reduction projects within a set share the same resources for developing their respective new subcomponent. At step 720, within each set, the GA dates of the cost reduction projects having the higher yearly cost savings are advanced earlier in time with advancement limited to their respective EBO date. In order to effectuate an advancement of a GA date, additional resources have to typically be assigned to the respective cost reduction project. As a result, advancing the cost reduction projects having the highest yearly cost savings may cause one or more cost reduction projects in the same set to have their GA dates delayed. Conversely, delaying a cost reduction project having a lower yearly cost savings, one or more cost reduction projects in the same set having high yearly cost savings may be advanced depending on the relative fixed cost of the delayed cost reduction project.

Each set of CR projects may be assigned to a project owner where the project owner is responsible for analyzing the cost savings of the set of CR projects, advancing the GA dates of higher cost saving CR projects, and, potentially, delaying the GA dates of lower cost savings CR projects. Alternatively, the prioritizing and tracking component 220 may include a threshold automatically categorizing those projects whose cost savings exceed the threshold as higher cost saving CR projects and categorizing those projects whose cost savings do not exceed the threshold as lower cost saving CR. In this environment, the GA dates of the higher cost saving CR projects may be advanced automatically, and the GA dates of the lower cost savings CR projects may be delayed automatically. An exemplary embodiment of how additional cost savings are achieved by advancing the GA date and the related effects of such advancement are discussed further commonly owned patent application entitled “System and Methods for Prioritizing and Tracking Cost Reduction Projects” U.S. patent application Ser. No. ______, filed concurrently with this application.

FIGS. 8-11 illustrate portions of the business case component of FIG. 2. FIG. 8 shows an exemplary spreadsheet utilized in implementing a first portion of the business case component of FIG. 2 implemented as a spreadsheet in accordance with the present invention. Spreadsheet 800 includes input areas 810, 815, 820, 830, 835, 837, 840, 845, and 847. Spreadsheet 800 also includes output areas 850A-850C and 855A-855C. Spreadsheet 800 compares three technologies defined by rows 840, 845, and 847, respectively.

Input area 810 reflects various configurations for an assembled product. For example, columns Q-Z in input area 810 contain labels indicating ten different configurations of the assembled product. Rows 840 includes a first set of subcomponents which, when assembled together, compose any one of the configurations in input area 810 of the assembled product. This first set of subcomponents in this exemplary spreadsheet defines a first technology. Rows 845 include a second set of subcomponents which, when assembled together, compose any one of the configurations in input area 810 of the assembled product. This second set of subcomponents in this exemplary spreadsheet defines a second technology. Rows 847 include a third set of subcomponents which, when assembled together, compose any one of the configurations in input area 810 of the assembled product. This third set of subcomponents in this exemplary spreadsheet defines a third technology. For ease of illustration, only three technologies are being shown. It should be noted that more than three technologies may be analyzed and compared in accordance with the teachings of the present invention.

Referring to input area 830 in column Q, the assembled product contains three part #2s, two part #4s, one part #5, and six part #7s to meet configuration #1 utilizing technology #1. Referring to input area 835 in the same column P, on the other hand, the assembled product contains three part #10s to meet the same configuration #1 utilizing technology #2. Furthermore, referring to input area 837 in the same column P, the assembled product contains three part #12s, two part #14s and one part #15s to meet the functions of configuration #1 utilizing technology #3. Each column in input areas 830, 835, and 837 is referred to as a usage factor for a corresponding configuration in the respective technology. A usage factor indicates a particular combination of subcomponents within a technology to meet a corresponding configuration of the assembled product.

Input area 815 contains the total yearly demand or forecast data for the configurations displayed in input area 810 of the assembled product. The data input area 815 is determined by contracts for sales of assembled product. Input area 820 distributes the yearly demand from input area 815 across the four quarters in an upcoming year according to the delivery time on won contracts. As the sales of any of the configurations go up, the total year demand for the corresponding configuration goes up accordingly. Consequently, when contracts are won or lost the data in input area 815 is modified manually or programmatically to reflect those sales conditions.

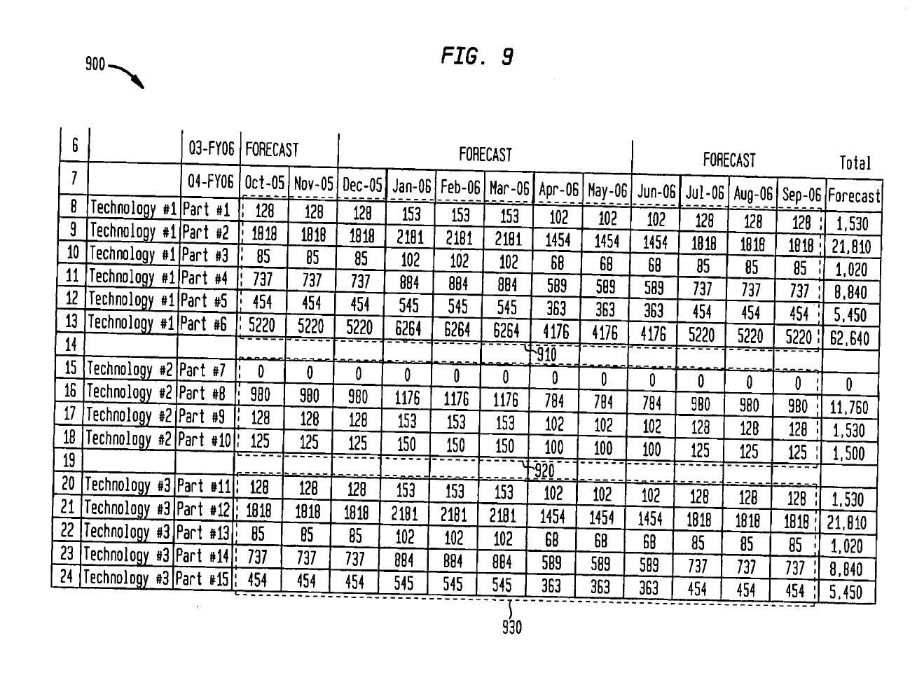

When modified programmatically, the business case component 260 allows for continuous input of supplier contracted pricing and direct purchase component costs. The business case component 260 continuously multiplies the usage factors in input areas 830 and 835 by updated forecast data for each assembled product configuration to calculate the forecast data on a subcomponent basis for each technology, the total subcomponent costs for each technology, and the total technology costs for each technology. The subcomponent forecast data is illustrated in FIG. 9.

Output areas 850A-850C show the costs as calculated for producing assembled product by the respective technologies on a subcomponent basis according to the forecast and configuration data. Output areas 855A-855C show the total costs or technology costs for producing assembled product by the respective technologies according to the forecast and configuration data. Since output 855B shows a total cost of 12.8 million and it is less than the other technologies, technology #2 is the most cost effective technology as compared to the other two technologies for the given forecast and configuration data.

It should be noted that even though the second technology is preferable over the other two technologies for the illustrated demand forecast, the other technologies may be preferable or less costly than the second technology over another range of forecast and configuration data. Utilizing the arrangement of data in FIG. 8, a business enterprise can justifiably decide on selecting a particular technology for a specific forecast and configuration data. Additionally, the business enterprise can observe different cost scenarios by modifying the forecast and configuration data to determine how resilient a particular technology is to changing forecast and configuration data. For example, a new configuration of assembled product can be added to see if technology costs are affected. To do so, usage factors would be added for each technology to meet the new configuration of assembled product. The technology costs in output areas 855A-855C would be automatically updated in response to the newly added configuration. Similarly, one or more configurations may be deleted from the technologies causing the technology costs in output areas 855A-855C to be automatically updated in response to the deleted configuration.

Once a technology is selected, the correspondingly selected subcomponents and usage factors may be transferred to the market based target cost (MBTC)/best of the best (BOB) component 210 for subsequent cost reduction projects. FIGS. 9-11 show spreadsheets utilized to calculate the total costs of the three different technologies.

When any of the input areas 815, 820, 830, 835, or 837 are modified, either manually or programmatically by interfacing with other software components of software 130, the output areas of spreadsheet 800 and the spreadsheets discussed in FIGS. 9-11 are automatically updated to reflect the corresponding modification.

FIG. 9 shows an exemplary forecast spreadsheet 900 of the subcomponents composing three different technologies of an assembled product in accordance with the present invention. Output area 910 shows the monthly forecast as calculated on an individual subcomponent basis for technology #1. Output area 920 shows the monthly forecast as calculated on an individual subcomponent basis for technology #2. Output area 930 shows the monthly forecast as calculated on an individual subcomponent basis for technology #3.

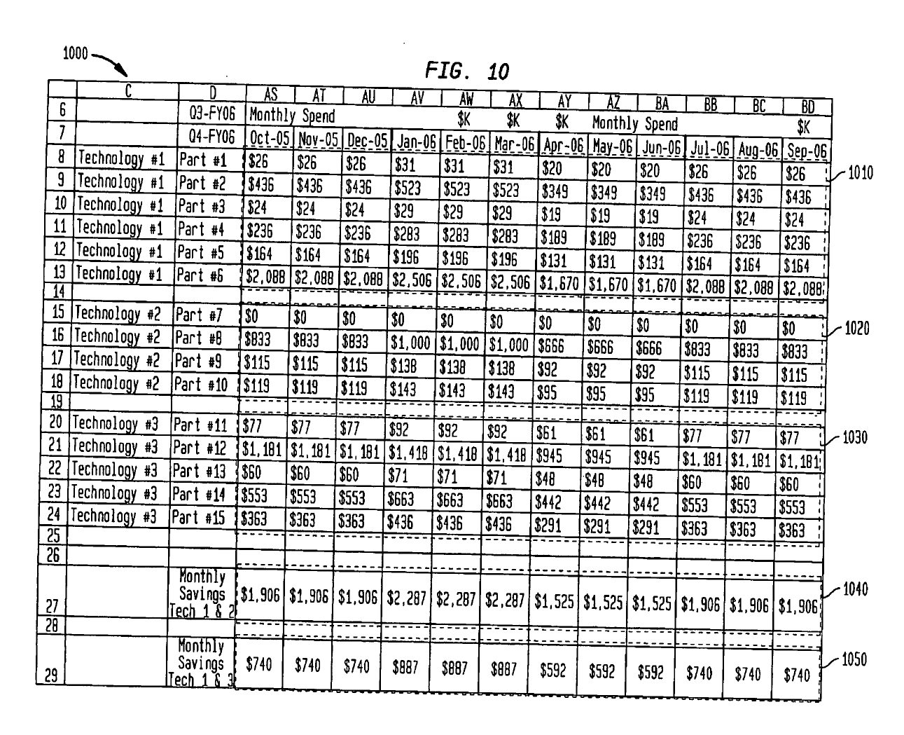

FIG. 10 shows an exemplary spreadsheet 1000 showing monthly costs for three technologies in accordance with the present invention. Output area 1010 shows the monthly costs as calculated from the forecast spreadsheet 900 on an individual subcomponent basis for technology #1. Output area 1020 shows the monthly costs as calculated from the forecast spreadsheet 900 on an individual subcomponent basis for technology #2. Output area 1030 shows the monthly costs as calculated from the forecast spreadsheet 900 on an individual subcomponent basis for technology #3. Output area 1040 shows a monthly savings as calculated of technology #2 over technology #1. Output area 1050 shows a monthly savings as calculated of technology #3 over technology #1. For ease of illustration, the monthly savings as calculated of technology #2 over technology #3 is not shown.

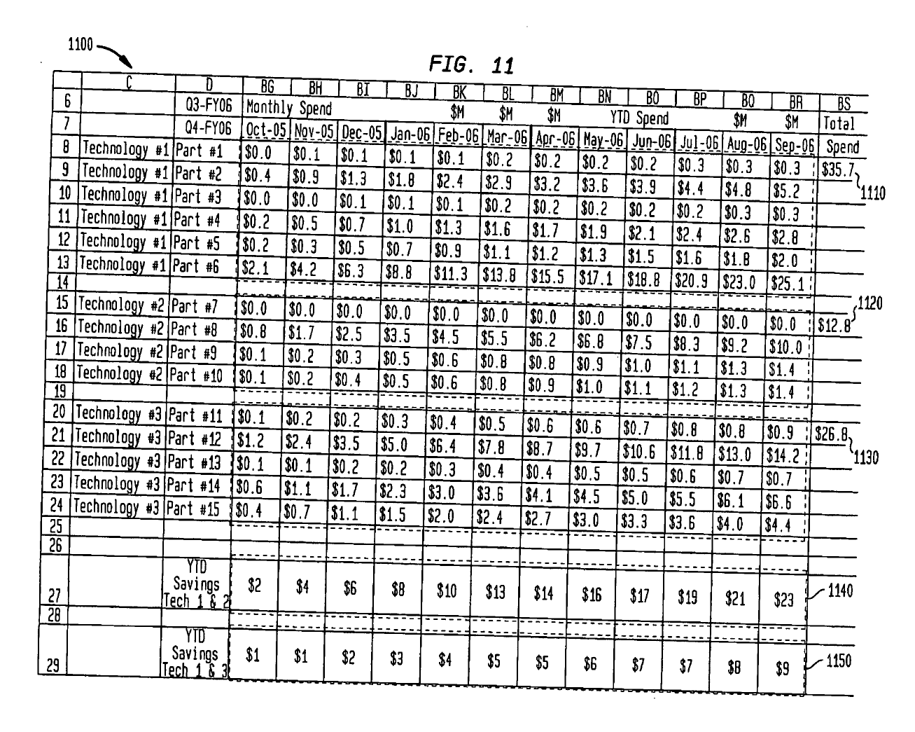

FIG. 11 shows an exemplary spreadsheet 1100 showing year to date costs for three technologies in accordance with the present invention. Output area 1110 shows the total amount that would be spent on technology #1 had technology #1 been utilized to supply assembled product. Output area 1120 shows the total amount that would be spent on technology #2 had technology #2 been utilized to supply assembled product. Output area 1130 shows the total amount that would be spent on technology #3 had technology #3 been utilized to supply assembled product. Output areas 1110, 1120, and 1130 are equal to output areas 855A-855C.

Output area 1140 shows a year to date savings as calculated of technology #2 over technology #1. Output area 1150 shows a year to date savings as calculated of technology #3 over technology #1. For ease of illustration, the monthly savings as calculated of technology #2 over technology #3 is not shown.

Another embodiment of FIGS. 8-11 includes creating records in memory or a database in system 100 based on the inputs discussed in FIG. 8. Software 130, in this embodiment, would also automatically select the least cost technology being considered.

While the present invention has been disclosed mainly in the generic context of sub-components and assembled products, it will be recognized that the present teachings are applicable to all manufactured products such as cell phones, internet protocol (IP) routers, wireless access points, or the like, which contain components manufactured or assembled by multiple suppliers.

We claim:

1. A computer implemented method of determining a business case for selecting a least cost technology, the method comprising:
receiving forecast sales data of one or more configurations of an assembled product;
receiving usage factors of a plurality of subcomponents composing the assembled product for a plurality of technologies, each usage factor corresponding to a combination of subcomponents to meet a configuration of the assembled product for one of the plurality of technologies;
receiving cost data for subcomponents composing the plurality of technologies; and
calculating a technology cost for each of the plurality of technologies according to the forecast sales data of one or more configurations of the assembled product to define the business case for selecting the least cost technology.

2. The computer implemented method of claim 1 further comprising:
comparing the technology cost of each of the plurality of technologies; and
selecting the technology from the plurality of technologies with the least cost.

3. The computer implemented method of claim 1 wherein the step of receiving forecast sales data of one or more configurations of assembled product is received continuously and wherein the technology cost for each of the plurality of technologies is correspondingly updated.

4. The computer implemented method of claim 1 further comprising:
adding a new configuration of assembled product; and
adding additional usage factors for the a plurality of subcomponents composing the assembled product, the additional usage factors corresponding to the new configuration of assembled product, said technology cost for each of the plurality of technologies automatically updated in response to the newly added configuration.

5. The computer implemented method of claim 1 further comprising:
deleting one of the one or more configurations of assembled product, said technology cost for each of the plurality of technologies automatically updated in response to the deleted configuration.

6. The computer implemented method of claim 1 wherein the calculating step further comprises:
determining forecast sales data on a subcomponent basis by applying the usage factors to the forecast sales data of one or more configurations of an assembled product.

7. A computer readable medium whose contents cause a computer to determine a business case for selecting a least cost technology, by performing the steps of:
receiving forecast sales data of one or more configurations of an assembled product;
receiving usage factors of a plurality of subcomponents composing the assembled product for a plurality of technologies, each usage factor corresponding to a combination of subcomponents to meet a configuration of the assembled product for one of the plurality of technologies;
receiving cost data for subcomponents composing the plurality of technologies; and
calculating a technology cost for each of the plurality of technologies according to the forecast sales data of one or more configurations of the assembled product to define the business case for selecting the least cost technology.

8. The computer readable medium of claim 7 further comprising:
comparing the technology cost of each of the plurality of technologies; and
selecting the technology from the plurality of technologies with the least cost.

9. The computer implemented method of claim 7 wherein the step of receiving forecast sales data of one or more configurations of assembled product is received continuously and wherein the technology cost for each of the plurality of technologies is correspondingly updated.

10. The computer readable medium of claim 7 further comprising:
adding a new configuration of assembled product; and
adding additional usage factors for the a plurality of subcomponents composing the assembled product, the additional usage factors corresponding to the new configuration of assembled product, said technology cost for each of the plurality of technologies automatically updated in response to the newly added configuration.

11. The computer readable medium of claim 7 further comprising:
deleting one of the one or more configurations of assembled product, said technology cost for each of the plurality of technologies automatically updated in response to the deleted configuration.

12. The computer readable medium of claim 7 wherein the calculating step further comprises:
determining forecast sales data on a subcomponent basis by applying the usage factors to the forecast sales data of one or more configurations of an assembled product.

13. A computer system for determining a business case for selecting a least cost technology comprising:
a processor; and
a memory containing:
a computer program;
forecast sales data of one or more configurations of an assembled product;
usage factors of a plurality of subcomponents composing the assembled product for a plurality of technologies, each usage factor corresponding to a combination of subcomponents to meet a configuration of the assembled product for one of the plurality of technologies; and
cost data for subcomponents composing the plurality of technologies wherein the processor executes the computer program to calculate a technology cost for each of the plurality of technologies according to the forecast sales data of one or more configurations of the assembled product to define the business case for selecting the least cost technology.

14. The computer system of claim 13 wherein the processor further executes the computer program to compare the technology cost of each of the plurality of technologies and to select the technology from the plurality of technologies with the least cost.
